(19) United States
(12) Patent Application Publication
(10) Pub. No.: US 2019/0281644 A1
(43) Pub. Date: Sep. 12, 2019

(54) BASE STATION AND TRANSMITTER AND RELAY COMMUNICATION DEVICES FOR CELLULAR AND D2D COMMUNICATION

(71) Applicant: HUAWEI TECHNOLOGIES CO., LTD., Shenzhen (CN)

(72) Inventors: Liang HU, Shenzhen (CN); Mohamed IBRAHIM, Munich (DE); Josef EICHINGER, Munich (DE)

(21) Appl. No.: 16/421,312

(22) Filed: May 23, 2019

Related U.S. Application Data
(63) Continuation of application No. PCT/EP2016/079001, filed on Nov. 28, 2016.

(51) Int. Cl. H04W 76/14; H04W 48/20; H04W 72/04; H04W 88/04; H04W 72/08; H04B 7/155

(52) U.S. Cl. CPC H04W 76/14; H04W 48/20; H04W 72/0406; H04W 92/18; H04W 72/085; H04B 7/15585; H04B 7/15528; H04W 88/04

(57) ABSTRACT

The invention relates to a base station for cellular communication with a plurality of communication devices configured for D2D communication using a D2D communication channel. The base station comprises: a communication interface configured to receive a request from the transmitter communication device; and a processor configured to select a subset of the plurality of relay communication devices for relaying the communication message to the at least one receiver communication device and to configure the subset of relay communication devices to relay the communication message using one of a plurality of relay modes.

### CROSS REFERENCE TO RELATED APPLICATIONS

This application is a continuation of International Application No. PCT/EP2016/079001, filed on Nov. 28, 2016, the disclosure of which is hereby incorporated by reference in its entirety.

### TECHNICAL FIELD

In general, the present embodiments of the invention relate to the field of wireless communications. More specifically, the present embodiments of the invention relate a base station and a transmitter communication device for cellular and D2D communication using one or more relay communication devices as well as corresponding methods.

### BACKGROUND

Device to device (D2D) communication between vehicles is considered as a key to improving road safety and preventing traffic congestion. The growing interest in applications of wireless technologies to vehicular environments leads to developments of technologies and protocols for data transmission between vehicles and between vehicles and road infrastructures. These emerging communication services, such as traffic safety, real-time remote monitoring, control of critical infrastructure and industrial autonomous control, raise new challenges for mobile radio wireless networks.

One of the most critical requirements for vehicular communication networks is the support of communication with low latency (less than few milliseconds) and high reliability (failure rate close to zero). The following use cases, in particular, require reliable low-latency communications for full autonomous driving functions.

By means of convoy driving vehicles in the same lane are grouped together in a stable formation with small inter-vehicle distances to increase road capacity, driver safety, and comfort. A convoy typically consists of one master, usually the leading vehicle, and multiple following vehicles. In order to maintain small inter-vehicle distances, convoy members rely on a high-frequency exchange of up-to-date and high-quality vehicle dynamic data among vehicles in the convoy. Convoy control algorithms require only the vehicle dynamics information of neighboring vehicles, instead of the information of all convoy members. As such, these algorithms scale well to large convoys and converge easily to a desired formation when vehicles join and leave the convoy.

In use cases of cooperative lane changes, cooperative vehicles (both autonomous and manually-driven) collaborate to perform lane changes of one or a group of cooperative vehicles (e.g., a convoy) in a safe and efficient manner. Unlike in a traditional lane change situation, cooperative vehicles share their planned trajectories by means of D2D communication in order to negotiate and align their maneuvers.

All of the above presented use cases, as well as autonomous driving in general, depend on an adequate and reliable perception of the vehicle surroundings in order to navigate through traffic and to ensure safety with a high level of automation (also referred to as cooperative sensing). Broken sensors, blind spots, and low level of trust in sensor data may degrade the performance or even disable automated functions of the vehicle.

The above use cases essentially require low-latency reliable D2D (in the automotive context also referred to as V2V) unicast/multicast communications. However, there are several challenges of enabling the cooperative multi-connectivity transmissions by relays. A first challenge is how to design low-latency and reliable protocols for cooperative multi-connectivity transmissions without the assistance of a cellular network (e.g., user equipments (UEs) in the RRC idle state or out of coverage). A second challenge is how to design low-latency and reliable protocols for cooperative multi-connectivity transmissions with a full or partial cellular network coverage. A third challenge is how to design a solution for cooperative node selections with minimized sidelink channel quality information exchange between communication devices and with consideration of future mobility of the communication devices.

A number of approaches for cooperative relay transmissions, including 3GPP relay, have been reported in the literature (3GPP TR 36.836, “Evolved Universal Terrestrial Radio Access (E-UTRA); Study on mobile relay”). For instance, an ad-hoc relay network architecture has been disclosed in IEEE ICC 2006, “Cooperative ARQ in Wireless Networks: Proctools and Performance” and in European Trans. on Telecomm 2005, “On the Performance of Cooperative Relaying Protocols in Wireless Networks,” by. E. Zimmermann, P. Herhold, and G. Fettweis. Enhancing relay functionality for IEEE 802.11/15.4/16j systems has been studied in IEEE JSAC 2011, “A Novel Adaptive Distributed Cooperative Relaying MAC Protocol for Vehicular Networks” and in IEEE Wireless Communications 2008, “IEEE 802.16j relay-based wireless access networks: an overview”. Moreover, previous works on relays for wireless industrial communications between master node and slave nodes can be found in “How to exploit spatial diversity in wireless industrial networks”, Elsevier Annual Reviews in Control, 2008.

However, none of the approaches mentioned above is designed for reliable low-latency communication systems. Thus, there is still a lack of relay network architectures for 5^{th} Generation (5G) heterogeneous Radio Access Technologies (RATs) and enhanced relay functionalities for 5G cellular network communication systems.

In light of the above, there is still a need for an improved base station as well as an improved transmitter communication device in a cellular and D2D communication network environment configured to use one or more relay communication devices as well as a corresponding method, which provide both low latency and high reliability.

### SUMMARY

It is an object of the embodiments of the invention to provide an improved base station as well as an improved transmitter communication device in a cellular and D2D communication network environment, which is in particular configured to use one or more relay communication devices as well as a corresponding method, which provide both low latency and high reliability.

The foregoing and other objects are achieved by the subject matter of the independent claims. Further implementation forms are apparent from the dependent claims, the description and the figures.

Generally, the present embodiments of the invention relate to devices and methods for transmitting messages in a wireless cellular and D2D communication system via cooperative transmissions with neighboring devices. More specifically, the present embodiments of the invention enable hybrid AF (Amplify and Forward) and DF (Decode and Forward) relay cooperative transmissions for enhancing the 3GPP LTE-D2D framework. Firstly, a single AF relay or multiple AF relays can be used to mainly improve SNR at short latency (no need to wait for decoding the original packet), by exploring both the proximity SNR gain and/or multipath diversity gain. Secondly, DF relays can be used to enable cooperative spatial diversity from multiple relays. It can be applied to mission-critical services requiring both high reliability and strict punctuality of packet delivery.

Embodiments of the present invention provide, amongst others, the following advantages: significant expansion of the coverage of reliable low-latency D2D communication by device cooperation, i.e. proximity Signal-to-Noise Ratio (SNR) gain and spatial diversity gain; great flexibility in trade-off between spectral efficiency and D2D coverage (low-latency reliable); great flexibility in cooperation with the cellular network assistance for better D2D relay selection and resource allocation; and great flexibility in dual-connectivity per node to provide more reliable control channel design.

More specifically, according to a first aspect the embodiment of the invention relates to a base station for cellular communication with a plurality of communication devices in a cellular communication network using a cellular communication channel, wherein the plurality of communication devices include a transmitter communication device, a plurality of relay communication devices and at least one receiver communication device and are configured for D2D communication with each other using a D2D communication channel. The base station comprises: a communication interface configured to receive a request from the transmitter communication device for transmitting a communication message from the transmitter communication device to the at least one receiver communication device; and a processor configured to select a subset of the plurality of relay communication devices for relaying the communication message to the at least one receiver communication device and to configure the subset of relay communication devices to relay the communication message using one of a plurality of relay modes, including a first relay mode and a second relay mode, wherein the first relay mode is an “amplify and forward” relay mode and wherein the second relay mode is a “decode and forward” relay mode.

Thus, an improved base station in a cellular and D2D communication network environment is provided configured to use one or more relay communication devices, which provides both low latency and high reliability.

In one embodiment of the base station according to the first aspect as such, the processor is further configured to estimate a quality measure, in particular a signal-to-noise ratio or a packet reception probability, of the D2D communication channel between the transmitter communication device and the receiver communication device and to instruct the transmitter communication device to transmit the communication message without the relay communication devices to the receiver communication device, in case the estimated quality measure is larger than a quality measure threshold.

In one embodiment of the base station, the processor is configured to select the subset of relay communication devices on the basis of a respective quality measure, in particular a signal-to-noise ratio, associated with each relay communication device, wherein the respective quality measure is based on the quality of the D2D communication channel between the transmitter communication device and the respective relay communication device and on the quality of the D2D communication channel between the respective relay communication device and the receiver communication device. In an implementation form the signal-to-noise ratio associated with a relay communication device can be the corresponding signal-to-noise ratio at the receiver communication device.

In one embodiment of the base station, the processor is configured to select the subset of relay communication devices by selecting the relay communication devices, for which the associated signal-to-noise ratio leads to an estimate of the block error rate based on the Polyanskiy bound or a variant thereof that is smaller than a block error rate threshold.

In one embodiment of the base station, the processor is configured to select the subset of relay communication devices on the basis of information about the position and/or the velocity of each relay communication device by predicting for each relay communication device a first channel quality of the D2D communication channel between the transmitter communication device and the relay communication device and a second channel quality of the D2D communication channel between the relay communication device and the receiver communication device. In an implementation form the first channel quality and the second channel quality can be a path loss along the respective D2D communication channels.

In one embodiment of the base station, the processor implements a Kalman filter, wherein the Kalman filter is configured to predict for each relay communication device the first channel quality and the second channel quality on the basis of a device position and velocity mobility model and/or a path loss model.

In one embodiment of the base station, for configuring the subset of relay communication devices the processor is configured to transmit via the communication interface a first control message for informing the subset of relay communication devices to relay the communication message using the first relay mode.

In one embodiment of the base station, the first control message further comprises information for identifying one or more communication resource blocks for transmitting the communication message.

In one embodiment of the base station, after transmitting the first control message and in response to receiving information that the receiver communication device was not able to decode, i.e. to correctly receive, the communication message, the processor is configured to re-configure the subset of relay communication devices to transmit via the communication interface a second control message for informing the subset of relay communication devices to relay the communication message to the receiver communication device using the second relay mode.

In one embodiment of the base station, the base station is configured to relay the communication message from the transmitter communication device to the at least one receiver communication device using the cellular communication channel and wherein the processor is configured to select the base station as part of the subset of the plurality of relay communication devices for relaying the communication message to the at least one receiver communication device.

In one embodiment of the base station, the processor is further configured to select one or more neighbouring base stations of the base station as part of the subset of the plurality of relay communication devices for relaying the communication message to the at least one receiver communication device and to inform the selected one or more neighbouring base stations to relay the communication message to the at least one receiver communication device.

According to a second aspect the embodiment of the invention relates to a transmitter communication device for cellular communication with a base station in a cellular communication network using a cellular communication channel and D2D communication with a plurality of communication devices using a D2D communication channel, the plurality of communication devices including a plurality of relay communication devices and at least one receiver communication device. The transmitter communication device comprises: a communication interface; and a processor configured to select on the basis of a cellular communication state of the receiver communication device a first communication message transmission mode and/or a second communication transmission mode. In the first communication message transmission mode the processor is configured to transmit via the communication interface a request to the base station for transmitting a communication message from the transmitter communication device to the receiver communication device. In the second communication message transmission mode the processor is configured to select a subset of the plurality of relay communication devices for relaying the communication message to the receiver communication device and to configure the subset of relay communication devices to relay the communication message using one of a plurality of relay modes, including a first relay mode and a second relay mode, wherein the first relay mode is an “amplify and forward” relay mode and wherein the second relay mode is a “decode and forward” relay mode, wherein the communication interface is configured to transmit the communication message to the one or more receiver communication devices via the subset of relay communication devices.

Thus, an improved transmitter communication device in a cellular and D2D communication network environment is provided configured to use one or more relay communication devices, which provides both low latency and high reliability.

In one embodiment of the transmitter communication device, the cellular communication state of the receiver communication device comprises a “RRC idle” state, a “RRC connected” state and an “Out of coverage” state.

In one embodiment of the transmitter communication device, the at least one receiver communication device comprises a first receiver communication device in a first cellular communication state, in particular a “RRC connected” state, and a second receiver communication device in a second cellular communication state, in particular in a “RRC idle” state or “Out of coverage” state, and the processor is configured to select the first communication message transmission mode for transmitting the communication message to the first receiver communication device and the second communication transmission mode for transmitting the communication message to the second receiver communication device.

According to a third aspect the embodiment of the invention relates to a method of operating a base station for cellular communication with a plurality of communication devices in a cellular communication network using a cellular communication channel, wherein the plurality of communication devices include a transmitter communication device, a plurality of relay communication devices and at least one receiver communication device and are configured for D2D communication with each other using a D2D communication channel. The method comprises the operations of: receiving a request from the transmitter communication device for transmitting a communication message from the transmitter communication device to the at least one receiver communication device; selecting a subset of the plurality of relay communication devices for relaying the communication message to the at least one receiver communication device; and configuring the subset of relay communication devices to relay the communication message using one of a plurality of relay modes, including a first relay mode and a second relay mode, wherein the first relay mode is an “amplify and forward” relay mode and wherein the second relay mode is a “decode and forward” relay mode.

The method according to the third aspect of the embodiment of the invention can be performed by the base station according to the first aspect of the embodiment of the invention. Further features of the method according to the third aspect of the embodiment of the invention result directly from the functionality of the base station according to the first aspect of the embodiment of the invention and its different implementation forms.

According to a fourth aspect the embodiment of the invention relates to a computer program comprising program code for performing the method of the third aspect when executed on a computer.

The embodiments of the invention can be implemented in hardware and/or software.

### BRIEF DESCRIPTION OF THE DRAWINGS

Further embodiments of the invention will be described with respect to the following figures, wherein:

FIG. 1 shows a schematic diagram of a cellular and D2D communication network comprising a base station, a transmitter communication device, a plurality of relay communication devices and a plurality of receiver communication devices according to an embodiment;

FIG. 2 shows a schematic diagram of a cellular and D2D communication network comprising a transmitter communication device, a plurality of relay communication devices classified into three different groups and a receiver communication device according to an embodiment;

FIG. 3 shows a schematic diagram of a cellular and D2D communication network comprising a base station, a transmitter communication device, a plurality of relay communication devices and a plurality of receiver communication devices according to an embodiment in a first communication scenario;

FIG. 4 shows a schematic diagram of a cellular and D2D communication network comprising a base station, a transmitter communication device, a plurality of relay communication devices and a plurality of receiver communication devices according to an embodiment in a second communication scenario;

FIG. 5 shows a schematic diagram illustrating the dual-connectivity provided by a cellular and D2D communication network according to an embodiment;

FIG. 6 shows a diagram illustrating a procedure for exchanging control and data messages during a first transmission stage in a communication scenario with full coverage of a cellular communication network according to an embodiment;

FIG. 7 shows a diagram illustrating a procedure for exchanging control and data messages during a second transmission stage in a communication scenario with full coverage of a cellular communication network according to an embodiment;

FIG. 8 shows a schematic diagram of the respective configuration of different control messages as used by a base station, a transmitter communication device, a relay communication device or a receiver communication device according to an embodiment;

FIG. 9 shows a flow diagram illustrating a procedure implemented in a transmitter communication device according to an embodiment;

FIG. 10 shows a diagram illustrating a procedure implemented in a base station according to an embodiment for including neighboring base stations as relay communication devices;

FIG. 11 shows a schematic diagram illustrating a method of operating a base station according to an embodiment;

FIG. 12 shows a diagram illustrating five different relay modes of a relay communication device according to an embodiment;

FIG. 13 shows a schematic diagram of a communication network comprising a transmitter communication device, a relay communication device and a receiver communication device according to an embodiment;

FIGS. 14A and 14B show graphs of the maximum spectral efficiency versus the signal-to-noise ratio (SNR) for different message sizes as achieved by embodiments of the invention;

FIG. 15 shows a schematic diagram of a time equalization approach implemented in a relay communication device according to an embodiment;

FIG. 16 shows a schematic diagram illustrating the selection of the best relay communication device within the line of sight of the receiver communication device and the transmitter communication device for analog beamforming as implemented in embodiments of the invention;

FIG. 17 shows a schematic diagram illustrating the estimation of a channel quality information (CQI) matrix on the basis of a Kalman filter as implemented in a base station and/or transmitter communication device according to an embodiment; and

FIG. 18 shows a schematic diagram illustrating possible assignments of relay communication devices to receiver communication devices according to an embodiment.

In the various figures, identical reference signs will be used for identical or at least functionally equivalent features.

### DETAILED DESCRIPTION OF EMBODIMENTS

In the following description, reference is made to the accompanying drawings, which form part of the disclosure, and in which are shown, by way of illustration, specific aspects in which the present embodiments of the invention may be placed. It will be appreciated that other aspects may be utilized and structural or logical changes may be made without departing from the scope of the present embodiments of the invention. The following detailed description, therefore, is not to be taken in a limiting sense, as the scope of the present embodiments of the invention is defined by the appended claims.

For instance, it will be appreciated that a disclosure in connection with a described method may also hold true for a corresponding device or system configured to perform the method and vice versa. For example, if a specific method operation is described, a corresponding device may include a unit to perform the described method operation, even if such unit is not explicitly described or illustrated in the figures.

Moreover, in the following detailed description as well as in the claims embodiments with different functional blocks or processing units are described, which are connected with each other or exchange signals. It will be appreciated that the present embodiments of the invention covers embodiments as well, which include additional functional blocks or processing units that are arranged between the functional blocks or processing units of the embodiments described below.

Finally, it is understood that the features of the various exemplary aspects described herein may be combined with each other, unless specifically noted otherwise.

Spatial diversity is an appealing physical enabler for achieving high reliability and low latency at the same time. Cooperative relaying transmission is one way to implement spatial diversity by exploring neighboring nodes cooperation, e.g., distributed virtual Multiple-Input and Multiple-Output (MIMO). Embodiments of the invention focus on cooperative transmissions that explore the multi-node spatial diversity. Cooperative multi-connectivity transmissions have the following advantages: a significant expansion of the coverage of reliable low-latency D2D communication by device cooperation, i.e., proximity Signal-to-noise ratio (SNR) gain and spatial diversity gain; and a great flexibility in trade-off between spectral efficiency and PC5 coverage (low-latency & reliable).

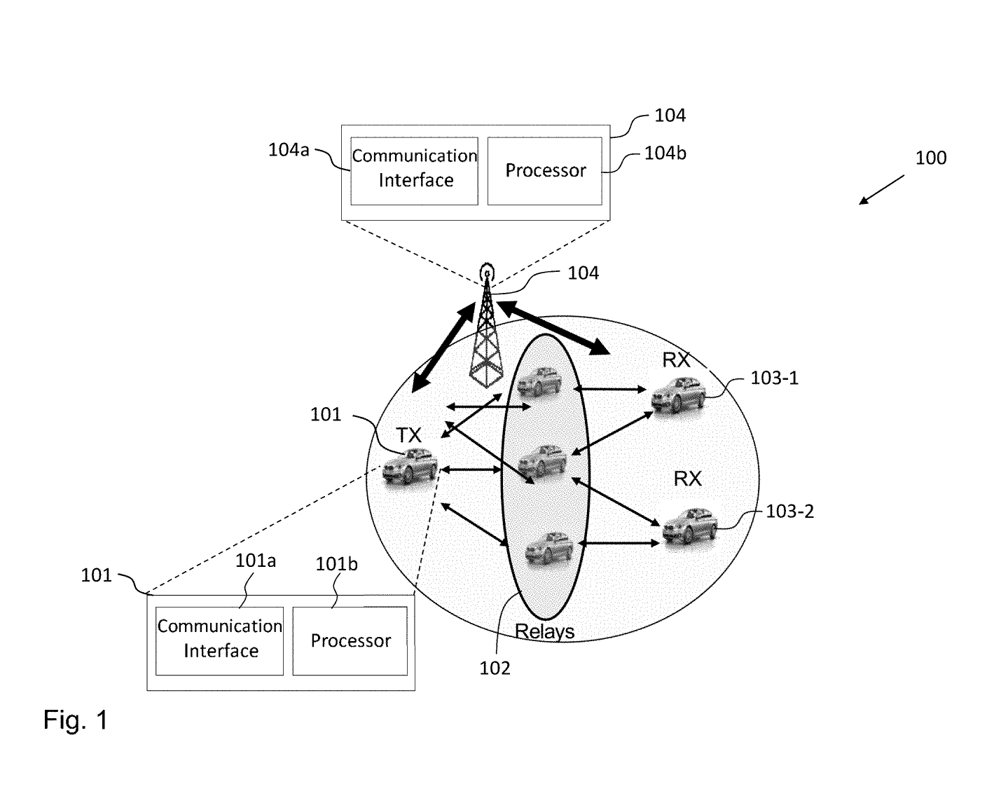

Embodiments of the invention can be implemented in the cellular and D2D communication network 100 shown in FIG. 1, comprising a transmitter communication device 101, a plurality of relay communication devices (which are collectively referred to with the reference sign 102 and individually with the reference signs 102-1, 102-2 and so forth), a plurality of receiver communication devices 103-1, 103-2 and a base station 104. In the exemplary D2D communication network 100 shown in FIG. 1, the plurality of communication devices are implemented as vehicles, in particular cars, having a cellular and D2D communication unit.

As can be taken from the detailed view shown in FIG. 1, the base station 104 comprises a communication interface 104a and a processor 104b.

The communication interface 104a of the base station 104 is configured to receive a request from the transmitter communication device 101 for transmitting a communication message from the transmitter communication device 101 to the at least one receiver communication device 103-1, 103-2.

The processor 104b of the base station 104 is configured to select a subset of the plurality of relay communication devices 102 for relaying the communication message to the at least one receiver communication device 103-1, 103-2 and to configure the subset of relay communication devices 102 to relay the communication message using one of a plurality of relay modes, including a first relay mode and a second relay mode, wherein the first relay mode is an “amplify and forward” relay mode and wherein the second relay mode is a “decode and forward” relay mode, as will be described in more detail further below.

In the following, a relay communication device 102 operating in the AF relay mode will also be referred to as AF relay and a relay communication device 102 operating in the DF relay mode will also be referred to as DF relay.

The number of the known receiver communication devices 103 can be one or multiple receiver communication devices 103, i.e., unicast or multicast transmissions. Normally, the unicast or multicast destination MAC addresses are known in advance, e.g., from application layer information exchange among nodes.

In an embodiment, the AF relay is effective when the received Signal-Noise-Ratio (SNR) between the transmitter communication device 101 and relay communication devices 102 are high; the amplification of the desired signal can be useful to overcome large path loss and noise from the relay communication devices 102 towards the receiver communication devices 103. On the other hand, the DF relay decodes and re-encodes the received signal, and then forwards it to the transmission. The DF relay does not cause noise amplification.

Embodiments of the invention provide signaling and algorithms that enable hybrid AF and DF relay cooperative transmissions for enhancing the 3GPP LTE-D2D framework. Single or multiple AF relays is used to mainly improve SNR at short latency (no need to wait for decoding the original packet), by exploring both the proximity SNR gain and/or multipath diversity gain. It is to be understood that the gain from multiple AF relays in terms of SNR cannot be computed in the close-form formula, due to the uncertainty of either destructive or constructive superposition of multiple received signals at the receiver communication device 103 from multiple AF relays (small-scale fading). Yet, there is a clear gain of SNR in the large-scale fading. The DF relay can also be used to enable cooperative spatial diversity from multiple relays.

As can be taken from the detailed view shown in FIG. 1, the transmitter communication device 101 comprises a communication interface 101a for cellular communication with the base station 104 and D2D communication with the relay communication devices 102 and the at least one receiver communication device 103-1, 103-2.

Moreover, the transmitter communication device 101 comprises a processor 101b configured to select on the basis of a cellular communication state of the receiver communication device 103-1, 103-2 a first communication message transmission mode and/or a second communication transmission mode.

In the first communication message transmission mode the processor 101b is configured to transmit via the communication interface 101a a request to the base station 104 for transmitting a communication message from the transmitter communication device 101 to the receiver communication device 103-1, 103-2.

In the second communication message transmission mode the processor 101b is configured to select a subset of the plurality of relay communication devices 102 for relaying the communication message to the receiver communication device 103-1, 103-2 and to configure the subset of relay communication devices 102 to relay the communication message using one of a plurality of relay modes, including a first relay mode and a second relay mode, wherein the first relay mode is an “amplify and forward” relay mode and wherein the second relay mode is a “decode and forward” relay mode, wherein the communication interface 101a is configured to transmit the communication message to the one or more receiver communication devices 103-1, 103-2 via the subset of relay communication devices 102.

In an embodiment, the cellular communication state of the receiver communication device 103-1, 103-2 can be a “RRC idle” state, a “RRC connected” state and an “Out of coverage” state.

In the following, further embodiments of the base station 104 and the transmitter communication device 101 will be described.

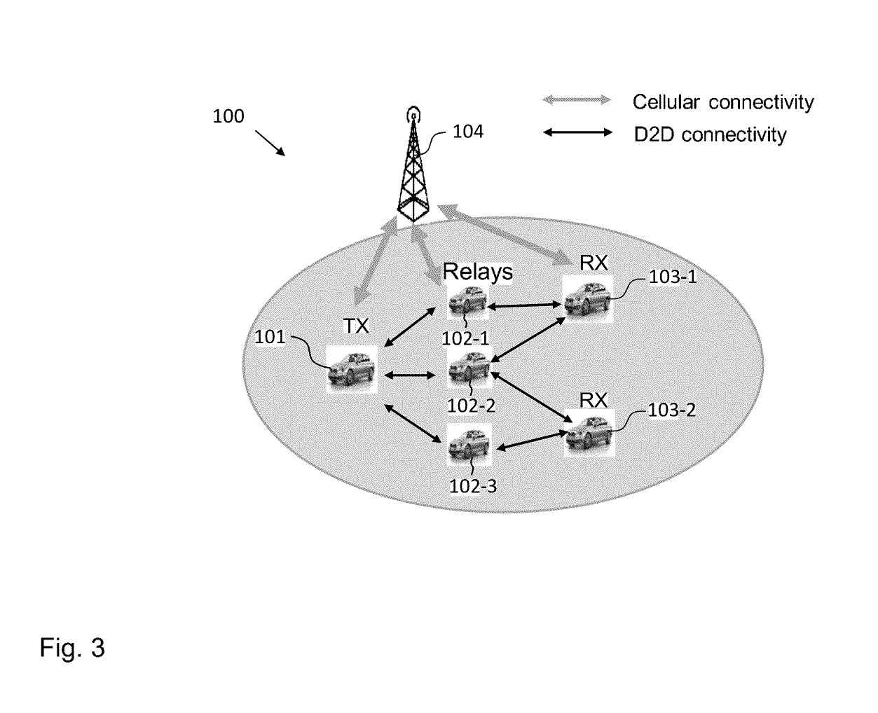

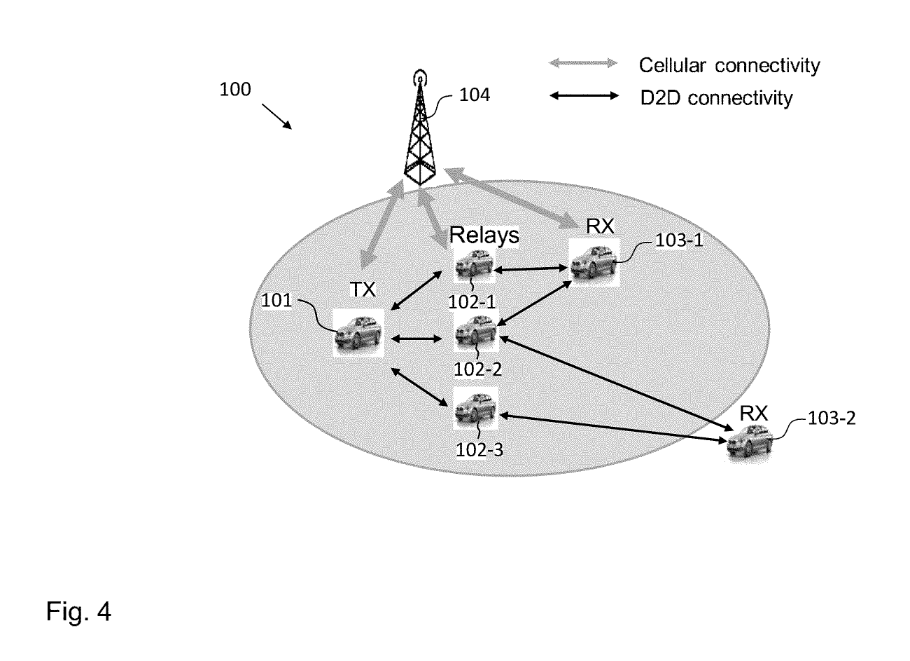

FIGS. 3 and 4 show schematic diagrams of the cellular and D2D communication network 100 including the transmitter communication device 101, the plurality of relay communication devices 102, the plurality of receiver communication devices 103-1, 103-2 and the base station 104 for cooperative multi-connectivity according to an embodiment in a first and second communication scenario. In the first scenario shown in FIG. 3 the transmitter communication device 101, the plurality of relay communication device 102, and the plurality of receiver communication devices 103 are all within coverage of the cellular network provided by the base station 104, while a subset of the plurality of the receiver communication devices 103 are out of coverage of the cellular network in FIG. 4.

Within the communication network 100 in partial coverage of the cellular network, the transmitter communication device 101 at the cell edge can inform the receiver communication devices 103 about the relay configuration of the cellular-organized transmission. In addition, the relay communication devices 102 can also be out of coverage of the cellular network, so the transmitter communication device 101 shall inform the relay communication devices 102 out of coverage to join cooperative transmissions.

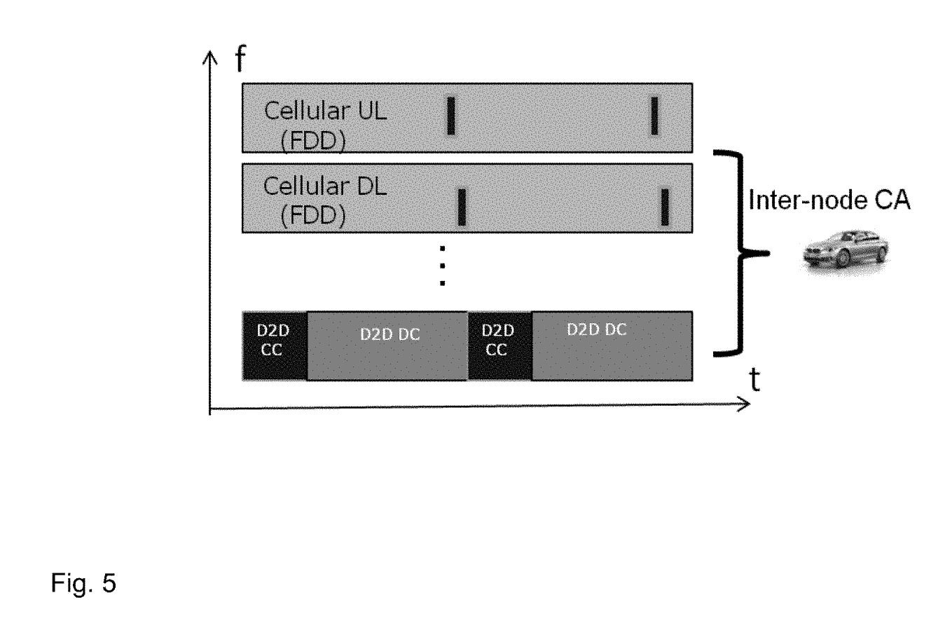

FIG. 5 shows a schematic diagram illustrating the dual-connectivity provided by the cellular and D2D communication network 100 according to an embodiment. In an embodiment, the cellular communication channel can be provided by the cellular Uu interface and the D2D communication channel can be provided by a PC5 interface.

As shown in FIG. 5, the communication devices can perform cooperative transmissions by leveraging dual-connectivity via the cellular Uu and D2D PC5 interfaces. The V2V control can take place both over the D2D resource pool (control channel) and the cellular control resource pool (uplink and downlink). In particular, the transmitter communication device 101 can request resource allocation and relay configuration from the base station 104 via the uplink control resource of the Uu interface. The base station 104 allocates resource and relay configuration to the communication devices via the downlink control resource of the Uu interface. Upon getting the grant from the network, the communication devices perform PC5-based communications including control message exchanges in the Control Channel (CC) pool and data transmissions in the Data Channel (DC) pool.

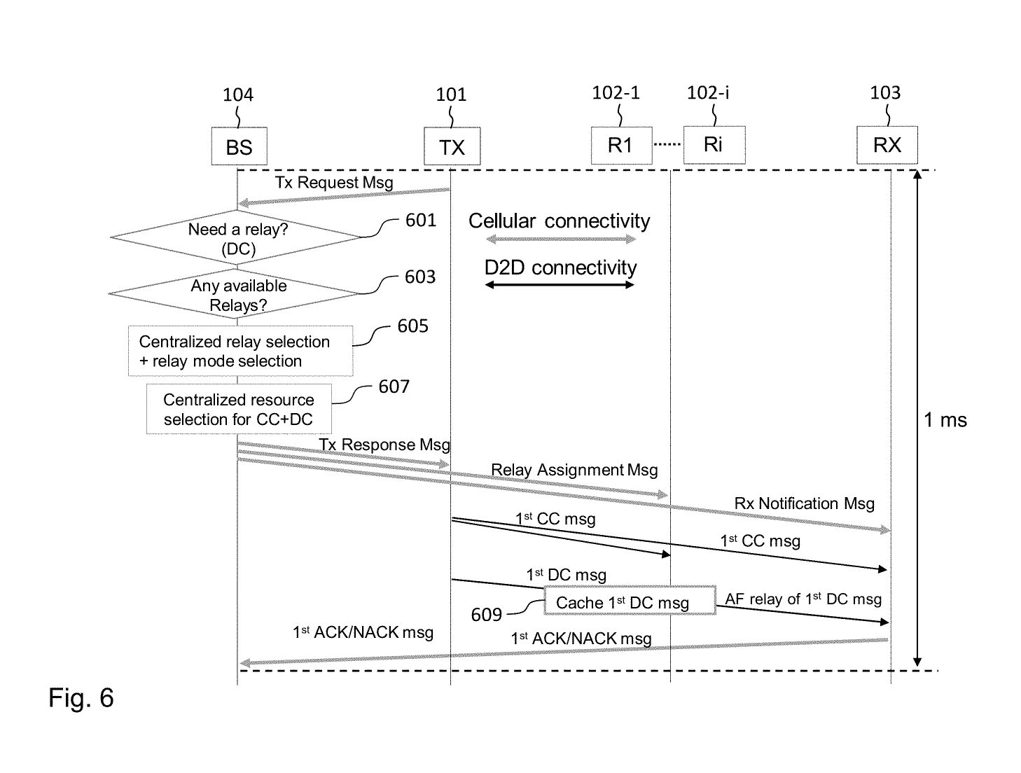

FIG. 6 shows a diagram illustrating a procedure for exchanging control and data messages during a first transmission stage in a full coverage communication scenario, i.e. a scenario where the transmitter communication device 101, the plurality of relay communication devices 102 and the receiver communication devices 103 are all within the coverage area of the cellular communication network provided by the base station 104. The procedure comprises the following operations.

The transmitter communication device 101 sends a request message to the base station 104 for relay configuration.

The base station 104 decides if a relay transmission is needed for Data Channel (DC) (operation 601).

If a relay is needed, the base station 104 evaluates if any relay communication device 102 is available (operation 603).

If the relay communication device 102 is available, the base station 104 performs a selection of centralized relay communication devices 102 and a selection of the relay modes (operation 605).

The base station 104 performs a selection of centralized resources for the Control Channel (CC) and for the Data Channel (DC) (operation 607).

The base station 104 sends a response message to the transmitter communication device 101, an assignment message to the relay communication devices 102, and a notification message to the receiver communication devices 103.

The transmitter communication device 101 sends a first CC message to the relay communication devices 102 and the receiver communication devices 103.

The transmitter communication device 101 sends a first DC message to the relay communication devices 102, and the relay communication devices 102 send the first DC message of the AF relay to a subset of the receiver communication devices 103. The first DC message can be cached in the relay communication devices 102 (see operation 609).

The receiver communication device(s) 103 send(s) a first set of ACK/NACK messages with respect to the AF relay to the base station 104.

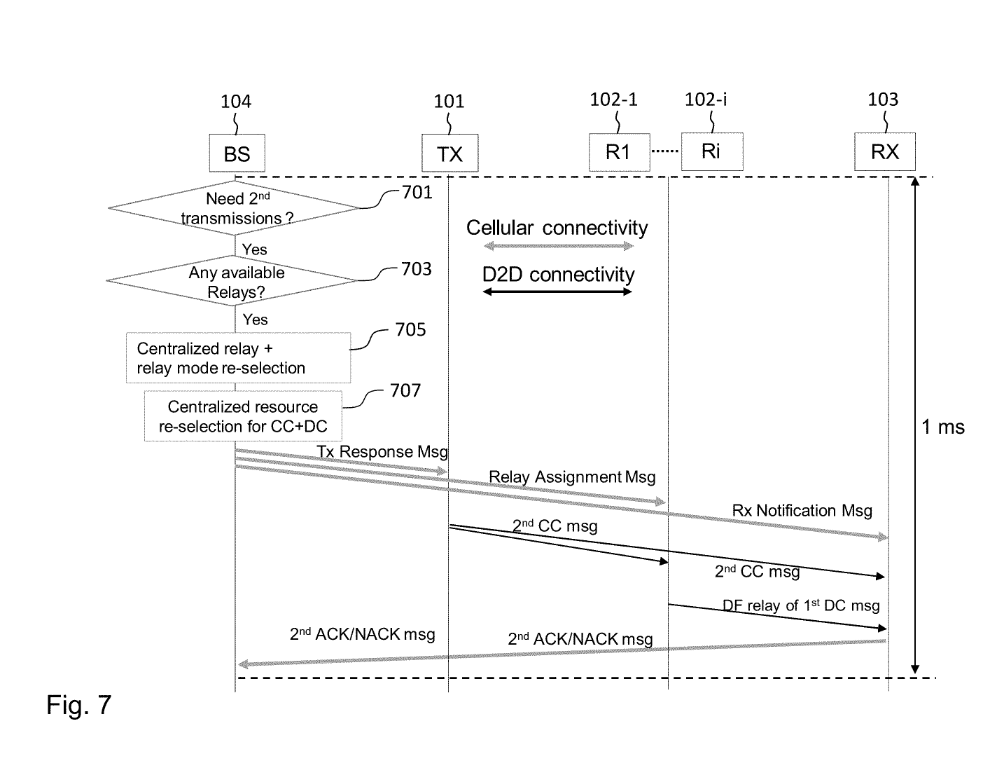

FIG. 7 shows a diagram illustrating a procedure for exchanging control and data messages during a second transmission stage in a full coverage communication scenario, i.e. a scenario where the transmitter communication device 101, the plurality of relay communication devices 102 and the receiver communication devices 103 are all within the coverage area of the cellular communication network provided by the base station 104. The procedure comprises the following operations.

The base station 104 decides if a second relay transmission is needed (operation 701).

If the second relay transmission is needed, the base station 104 evaluates if any relay communication device 102 is available (operation 703).

If the relay communication device 102 is available, the base station 104 performs a re-selection of the centralized relay communication devices 102 and a re-selection of the relay modes (operation 705).

The base station 104 performs a re-selection of centralized resources for the Control Channel (CC) and for the Data Channel (DC) (operation 707).

The base station 104 sends a response message to the transmitter communication device 101, an assignment message to the relay communication devices 102, and a notification message to the receiver communication devices 103.

The transmitter communication device 101 sends a second CC message to the relay communication devices 102 and the receiver communication devices 103.

The relay communication devices 102 send a first DC message of the DF relay to a subset of the receiver communication devices 103.

The receiver communication device 103 sends a second set of ACK/NACK messages with respect to the DF relay to the base station 104.

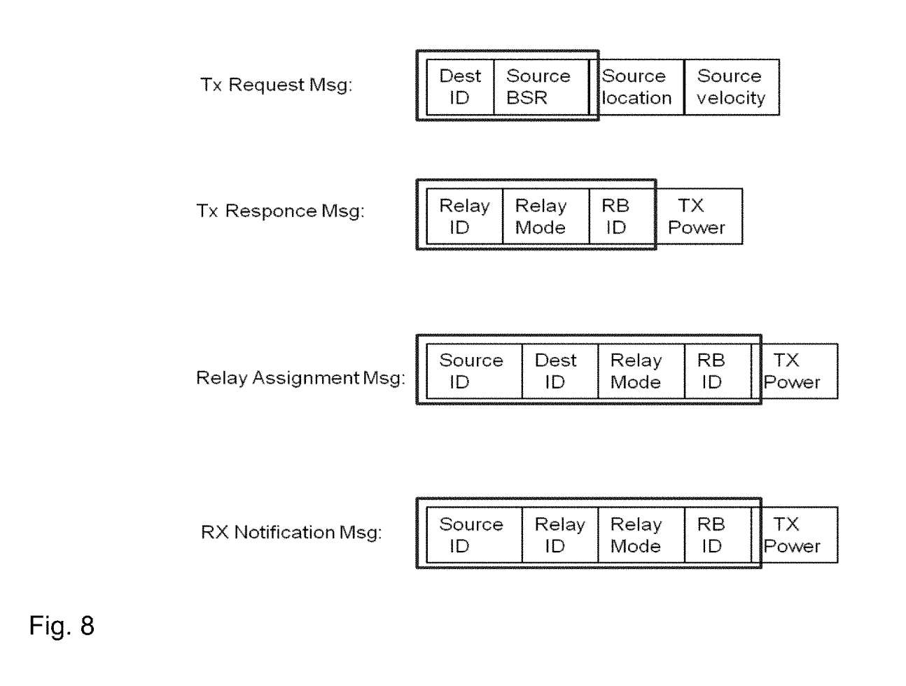

FIG. 8 shows a schematic diagram of the respective configuration of different control messages as used by the base station 104, the transmitter communication device 101, the relay communication devices 102 or the receiver communication devices 103 according to an embodiment. More specifically, FIG. 8 shows the messages exchanged between the communication devices during the first and second transmission stages described in the context of FIGS. 6 and 7. The exchange messages include a transmitter request message (Tx Request Msg), a transmitter response message (Tx Response Msg), a relay assignment message (Relay Assignment Msg), and a receiver notification message (RX Notification Msg).

The Tx Request Msg comprises a request for relay configuration intended for the base station 104, which can be transmitted over the cellular communication channel, such as the cellular uplink control channel, e.g., by using PUCCH format 2. The Tx Response Msg can be transmitted over the cellular PDCCH using extended DCI format 5. The Relay Assignment Msg and the receiver notification message “RX Notification Msg” can be transmitted over cellular PDCCH using extended DCI format 5.

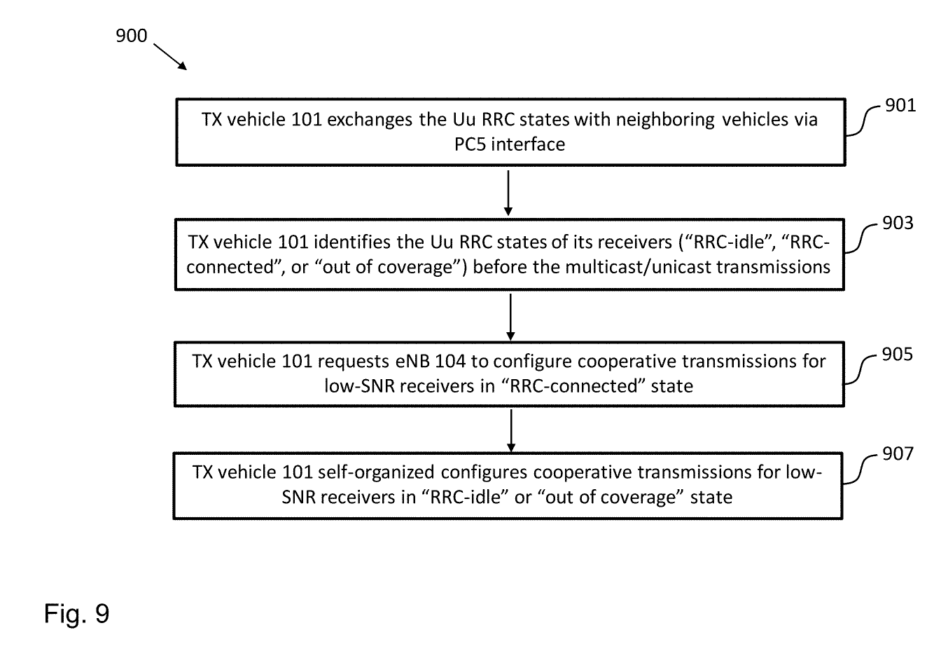

FIG. 9 shows a flow diagram illustrating a procedure implemented in the transmitter communication device 101 according to an embodiment for configuring a plurality of communication devices for cooperative relay transmissions in a communication scenario with partial coverage of the cellular network, i.e. where the transmitter communication device 101, the plurality of relay communication devices 102, and a subset of the plurality of receiver communication devices 103 are in coverage of the cellular network provided by the base station 104, but a subset of the plurality of receiver communication devices 103 is out of coverage of the cellular network provided by the base station 104.

In partial coverage of the cellular network, the transmitter communication device 101 can configure the subset of the plurality of receiver communication devices 103 which are not inside the coverage of the cellular network. Prior to the cooperative transmission, the transmitter communication device 101 can be informed of the cellular communication states, in particular the Uu RRC (Radio Resource Control) states, of the receiver communication devices 103 or can estimate these states of the receiver communication devices 103 by itself. The transmitter communication device 101 requests the base station 104 (referred to in FIG. 9 as eNB) to configure the subset of the plurality of receiver communication devices 103 in a ‘RRC-connected’ state for cooperative transmission. On the other hand, the transmitter communication device 101 decides and configures the subset of the plurality of receiver communication devices 103 in a ‘RRC-idle’ state for cooperative transmission. The transmitter communication device 101 also can inform and configure the relay communication devices 102 which are out of coverage of the cellular network. The process 900 shown in FIG. 9 comprises the following operations.

The transmitter communication device 101 exchanges the Uu RRC states with the neighboring receiver communication devices 103 via its PC5 interface (operation 901).

The transmitter communication device 101 identifies the Uu RRC states, i.e. the cellular communication states, of its receiver communication devices 103 (“RRC-idle”, “RRC-connected”, or “out of coverage”) before the multicast/unicast transmissions (operation 903).

The transmitter communication device 101 requests the base station/eNB 104 to configure cooperative transmissions for the low-SNR receiver communication devices 103 in a “RRC-connected” state (operation 905), i.e. selects or operates in the first communication message transmission mode.

The transmitter communication device 101 configures cooperative transmissions for low-SNR receiver communication devices 103 in a “RRC-idle” or a “out of coverage” state in a self-organized way (operation 907), i.e. selects or operates in the second communication message transmission mode.

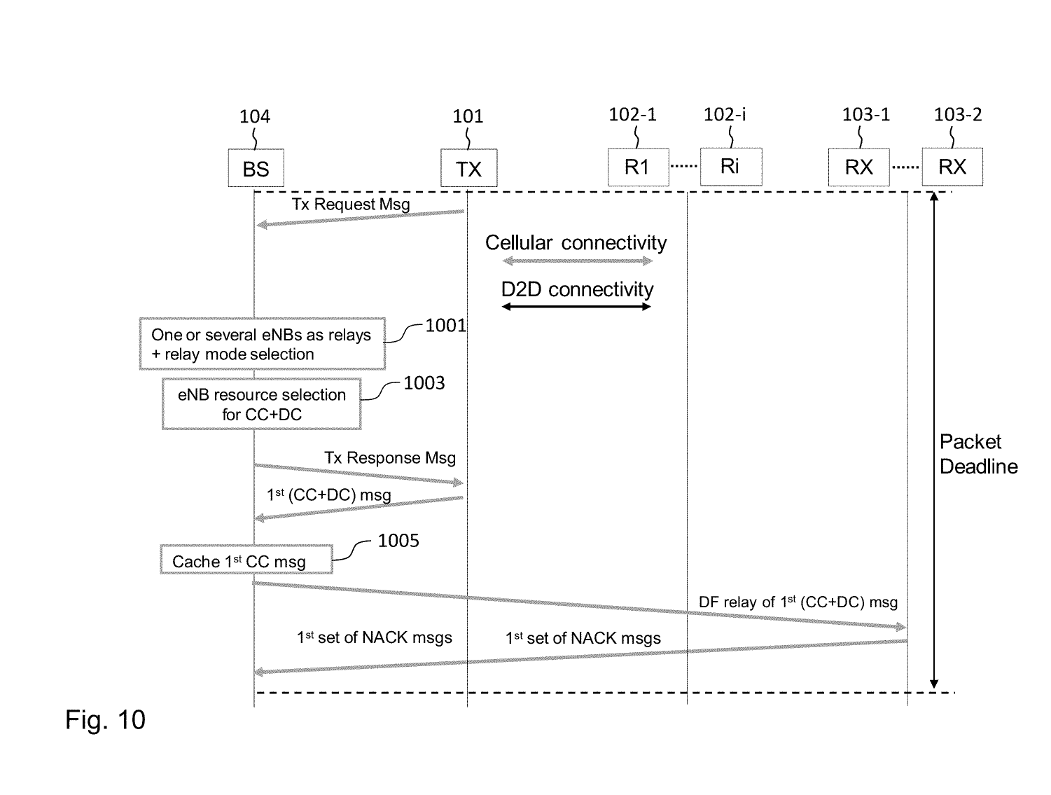

FIG. 10 shows a diagram illustrating a procedure implemented in the base station 104 according to an embodiment for including itself and/or neighboring base stations as further relay communication devices. In this way the base station 104 can also join the cooperative multi-connectivity transmission to leverage its larger antenna gain. On request from the transmitter communication device 101, one or multiple base stations can be activated to perform multi-connectivity transmission. The procedure shown in FIG. 10 comprises the following operations.

The transmitter communication device 101 requests cooperative transmission configuration (i.e. to transmit a communication message) from the base station 104 via the Uu interface.

The base station 104 checks if a relay is needed and selects the relay configuration (operation 1001).

In selecting the optimal relay configuration, the base station 104 can decide to join the cooperative transmissions by acting as a relay communication device (operation 1003). It can also inform other neighboring base stations via a X2 interface to join the cooperative transmissions together.

The base station 104 informs the transmitter communication device 101 about the relay configuration, i.e. about which base station(s) will act as a relay communication device.

The transmitter communication device 101 transmits the control and data messages via the Uu interface to the base station 104.

The base station(s) decode and forward, i.e. relay the data messages to the receiver communication devices 103. A corresponding first control message provided by the transmitter communication device 101 can be cached in the base station(s) (operation 1005).

The base station 104 receives a set of NACK(s) messages from the failed receiver communication devices 103.

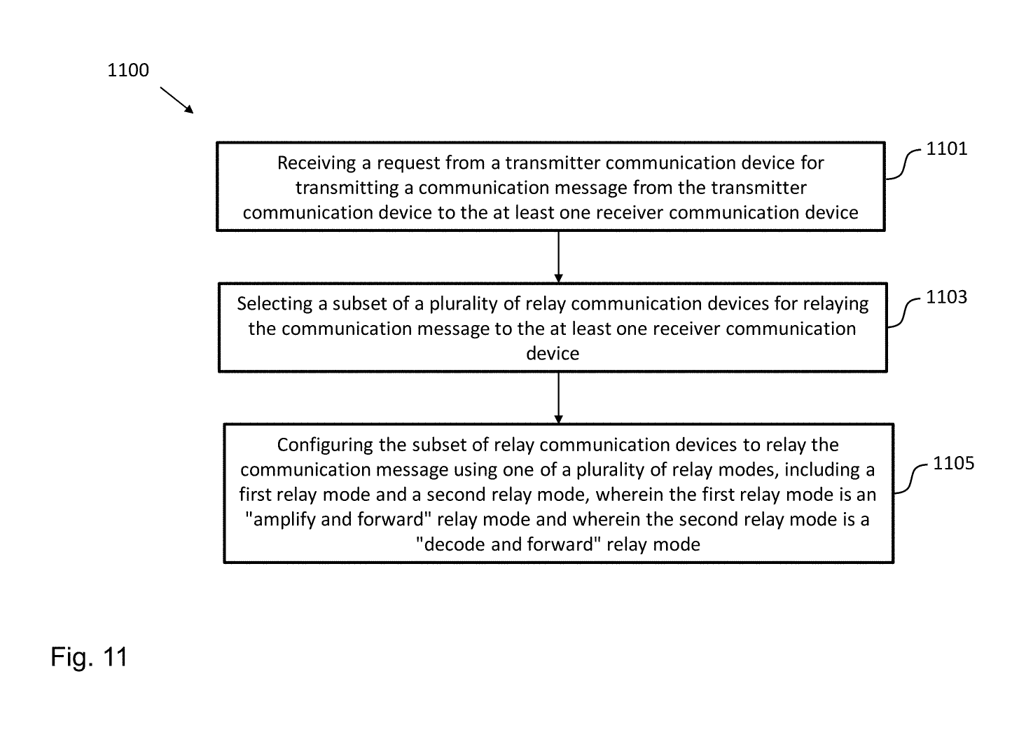

FIG. 11 shows a schematic diagram illustrating a method 1100 of operating the base station 104 according to an embodiment. The method 1100 comprises the operations of: receiving 1101 a request from the transmitter communication device 101 for transmitting a communication message from the transmitter communication device 101 to the at least one receiver communication device 103-1, 103-2; selecting 1103 a subset of the plurality of relay communication devices 102 for relaying the communication message to the at least one receiver communication device 103-1, 103-2; and configuring 1105 the subset of relay communication devices 102 to relay the communication message using one of a plurality of relay modes, including a first relay mode and a second relay mode, wherein the first relay mode is an “amplify and forward” relay mode and wherein the second relay mode is a “decode and forward” relay mode.

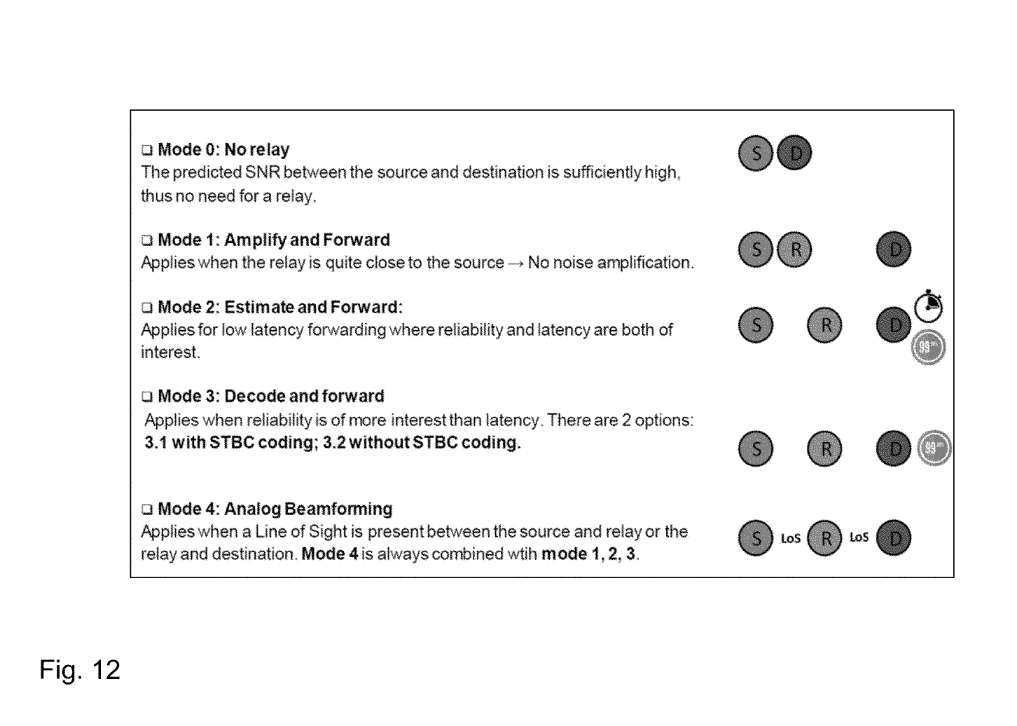

FIG. 12 illustrates five different types of relay configurations according to embodiments of the invention. The base station 104 or the transmitter communication device 101 can configure five relay modes in order to achieve high reliability and low latency at the same time within the communication network 100.

Mode 0 (No relay): The predicted SNR between the source and destination is sufficient high, thus there is no need for a relay.

Mode 1 (Amplify and Forward): the AF relay simply amplifies the source signal and re-transmits. As a drawback, noise will also be amplified in the meantime. Thus, it can apply when the relay is quite close to the source, so that there is less noise amplification.

Mode 2 (Estimate and Forward): It applies for low latency forwarding wherein reliability and latency are both of interest. To improve the SNR of the AF relay, a time equalization approach can be used, wherein a fast time domain equalization procedure is undertaken, wherein an inverse of the frequency response is transformed into the time domain. Once an inverse time domain frequency response is obtained, the relays 102 operating in this mode can convolve the baseband data signal using the inverse channel filter, “cleaning” up the signal before forwarding.

Mode 3 (Decode and Forward): the DF relay decodes the source transmission, re-encodes and re-transmits. Advantageously, noise amplification is less an issue. Thus, it can be used when reliability is more important than latency. There are 2 options for the DF relay mode: with or without STBC (Spatial Time Block Coding), as will be described in more detail further below.

Mode 4 (Analog Beamforming): It can be used when the source is within the line of sight of the relay communication devices 102 or the relay communication devices 102 are within the line of sight of the destination. The base station 104 or the transmitter communication device 101 can choose the relay communication devices 102 whose line of sight is within the transmitter communication devices 101 or the receiver communication device 103 in order to increase the signal. The analog beamforming in the second hop can be optional (for example in multicast). Mode 4 can be combined with mode 1, 2, 3.

The different relay configurations are indicated in the “relay mode” field in the CC (control channel) messages, as described in the context of FIG. 8 above.

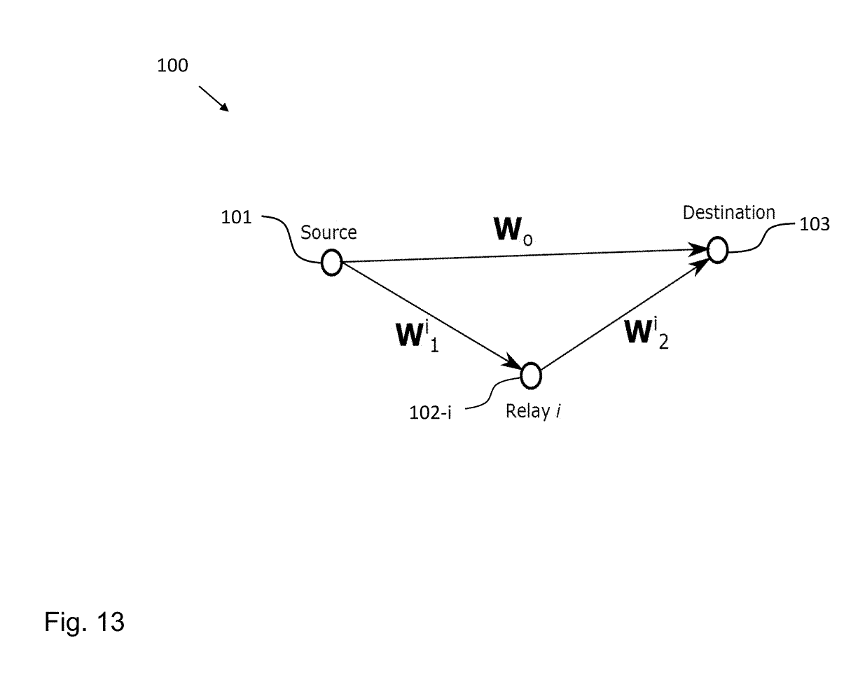

FIG. 13 shows a schematic diagram of a relay setup in the communication network 100, wherein a communication message may need to be delivered from the source, i.e. the transmitter communication device 101, to the destination, i.e. the receiver communication device 103, either directly through the channel Wₒ or through the relay communication device 102-i with double hop channels indicated as Wᵢ¹ and Wᵢ².

It can be shown that the average SNR through the relay communication device 102-i can be estimated on the basis of the following equation:

$${γ}_{eff}^{relay , i} = ( \frac{{σ}_{x}^{2}}{{σ}_{z 1}^{2}} ) \cdot ( \frac{tr ( {R}_{1} {R}_{2} )}{tr ( {R}_{2} ) + {N}_{d} \frac{{σ}_{z 2}^{2}}{{a}^{2} {σ}_{z 1}^{2}}} )$$

wherein R₁ and R₂ are the autocovariance matrix of the first and second hop respectively, N_{d} is the number of data symbols, a is the amplification factor, σ²_{z1} and σ²_{z2} are the noise powers of the first and second hops, respectively.

The SNR through each candidate relay communication device 102 to each receiver communication device 103 can be grouped into a vector of SNRs as

γ_{eff}^{relay}=[γ_{eff}^{relay,1}γ_{eff}^{relay,2} . . . γ_{eff}^{relay,N}].

In the unicast case, the elements of the vector are scalars representing the SNR from the transmitter communication device 101 to the receiver communication device 103. In the multicast case, the elements of the vector are the SNR averaged over all receiver communication devices 103.

Activating more relays increases the apparent SNR at the receiver communication device 103. However, it would also increase the interference to other neighboring clusters using the same time frequency resources. Therefore, a certain maximum number of relay communication devices 102 can be selected based on their effective SNR value.

The achievable SNR at the receiver communication device 103 when the relay communication devices 102 are activated may still not be sufficient to correctly decode the transmission message. Whether the SNR is sufficient or not, can be determined by the Polyanskiy bound. The Polyanskiy bound takes the message size in bits, the available symbols for transmission, the SNR and yields the probability of error in delivering this message size.

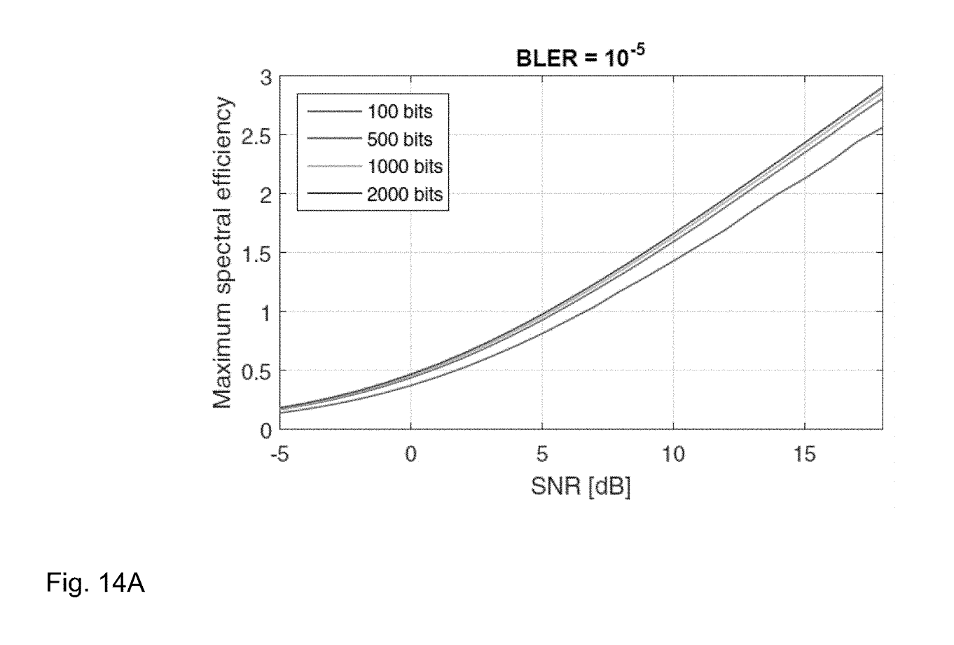

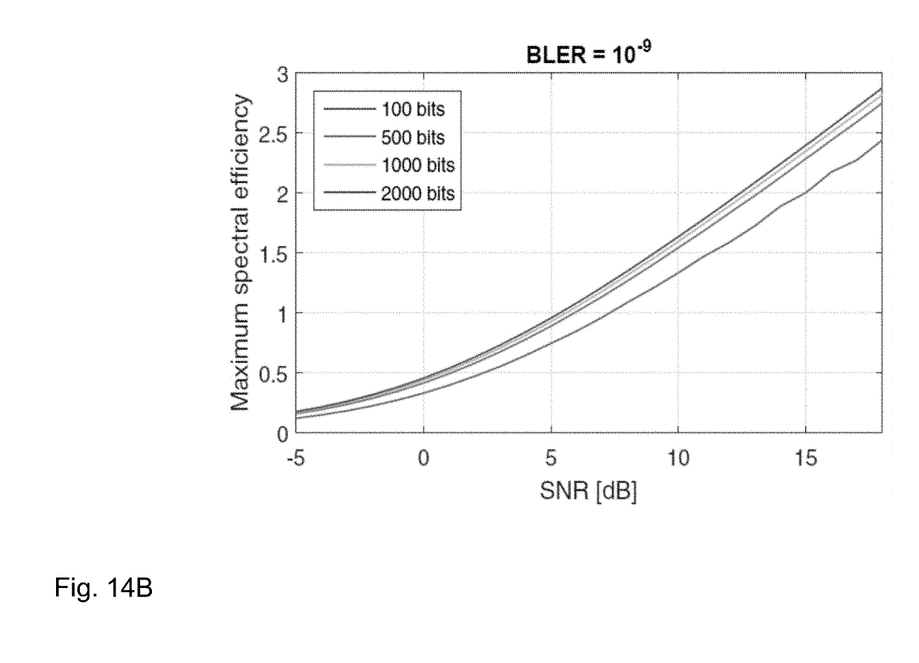

FIGS. 14A and 14B show the maximum possible spectral efficiency versus SNR for different message sizes. As an example, given that the message size is 100 bits and that the modulation and coding scheme used are fixed to a spectral efficiency of 2 bits/sec/Hz, and that the target block error rate is 10⁻⁵. As shown in FIGS. 14A and 14B, the minimum required SNR is nearly 14.2 dB. This bound assumes optimal modulation and coding with Gaussian symbol inputs. Such assumption might be generally not realistic. Hence, it is suitable to add a fixed margin on top of the computed SNR, which takes into account imperfect modulation and coding.

If the resultant SNR of the Amplify and Forward (AF) relay 102 is not sufficient, then the transmitter communication device 101 can resort to some possible enhancements for boosting the SNR. Below two methods for enhancing the SNR are described, as implemented in embodiments of the invention.

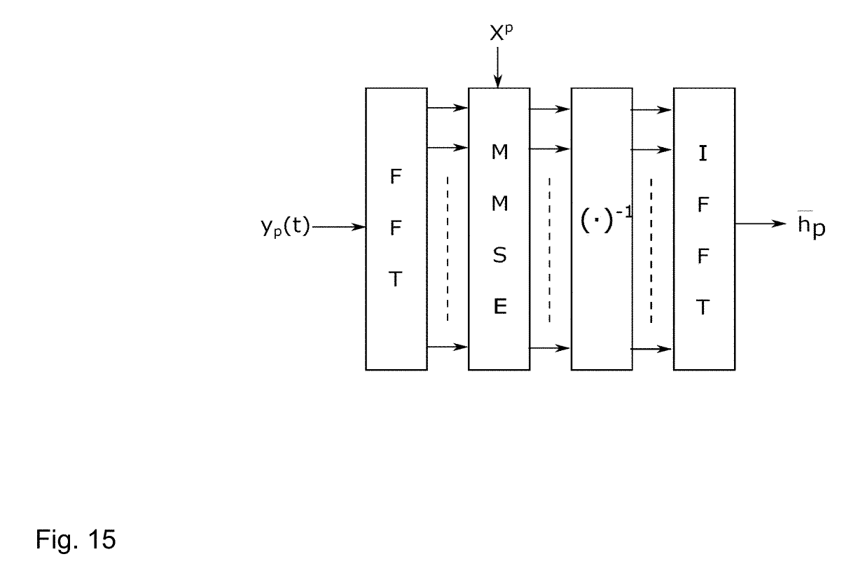

AF relays simply forward the analog signal they obtain without any form of equalization. In order to improve the SNR, some sort of equalization may be introduced at the relay communication devices 102. However, due to the low latency constraints the equalization should be done within “one shot”. Therefore, a time equalization approach is provided by embodiments of the invention, wherein the relay communication device 102 obtains an estimate of the frequency response of the channel from the preamble, then obtains an inverse of the frequency response. The inverse frequency response is transformed to the time domain. The operation of the time equalization approach is illustrated in FIG. 15.

Once an inverse time domain frequency response is obtained, the relay communication device 102 can convolve the baseband data signal using the inverse channel filter. In this way, the relay communication device 102 does not need to apply a FFT to the data symbols and interpolate the channel's response in the frequency domain; instead, a fast time domain equalization procedure can be undertaken. This low latency relay operation can help “cleaning-up” the signal before forwarding it.

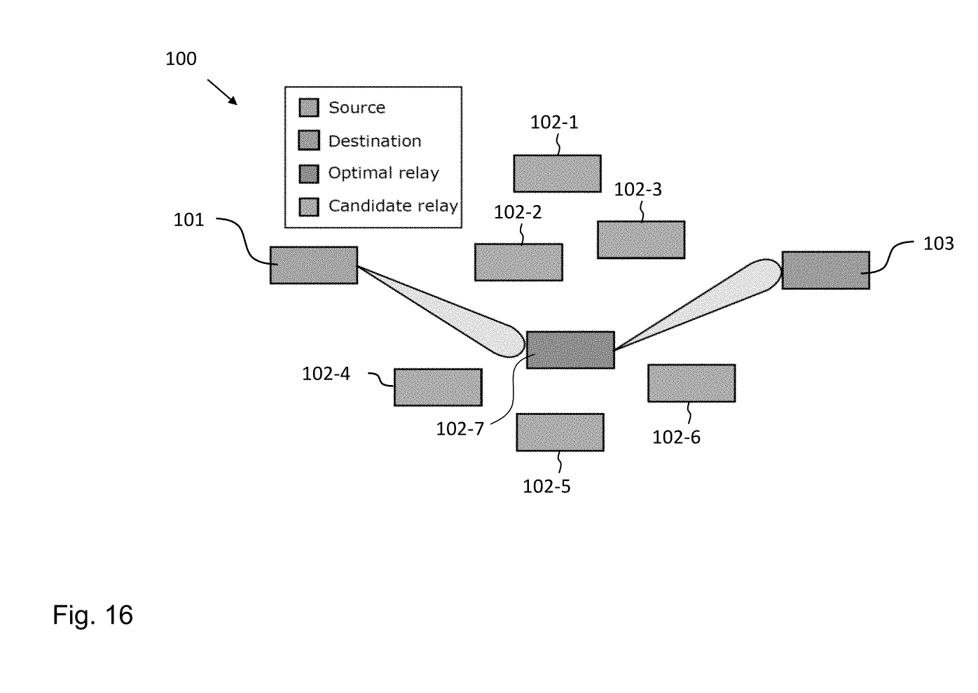

In V2V situations, there is a high probability that a relay communication device 102 is within the line of sight of another relay communication device 102. According to an embodiment, analog beamforming capabilities of the communication devices can be used to focus the beams on the intended receiver communication device 103 (Mode 4 relay). This is especially useful in the case of unicast transmission (in particular with a single relay communication device 102). Therefore, the base station 104 or the transmitter communication device 101 will choose the relay communication device 102 whose line of sight is within the receiver communication device 102 and the transmitter communication device 101. The analog beamforming in the second hop is optional (for example in multicast). FIG. 16 shows an example of how the base station 104 or the transmitter communication device 101 may pick up an optimal relay communication device 102-7 among a plurality of relay communication devices 102-1 to 102-7.

If the first transmission fails, the destination (unicast) or destinations (multicast) can send back a NACK message indicating that it has failed to decode the message. The source, i.e. the base station 104 or the transmission device 101, now can trigger a second transmission with higher chances of decoding than the first transmission. In other words, the base station 104 or the transmitter communication device 101 can seek a transmission strategy which increases the SNR compared to the first transmission. In this situation, the source can configure at least two relays communication devices 102 to perform a decode and forward (Mode 3 relay) transmission using Alamouti coding. The relay has relatively long time between the first transmission and the second transmission. This time can be used by the channel coding module to perform several channel decoding iterations. Being an open loop diversity scheme, Alamouti coding is suitable for this scenario since no channel knowledge is needed at the base station 104 or the transmitter communication device 101. Ideally, for uncorrelated antennas, Alamouti offers a 3 dB increase in SNR compared to single antenna transmission.

Relay selection is a well-studied area in wireless communications. However, according to an embodiment, there is an ad-hoc network wherein nodes exchange CAM messages comprising their location coordinates, velocity and acceleration. The messages are exchanged periodically in a broadcast manner. Those messages can be exchanged in an 802.11p-like protocol. Some CAM message packet errors are acceptable for the functioning of the following system. According to an embodiment, CAM messages are used for a cross-layer protocol which uses the location and velocity of the neighbors to predict the best possible relay nodes for forwarding the mission critical message.

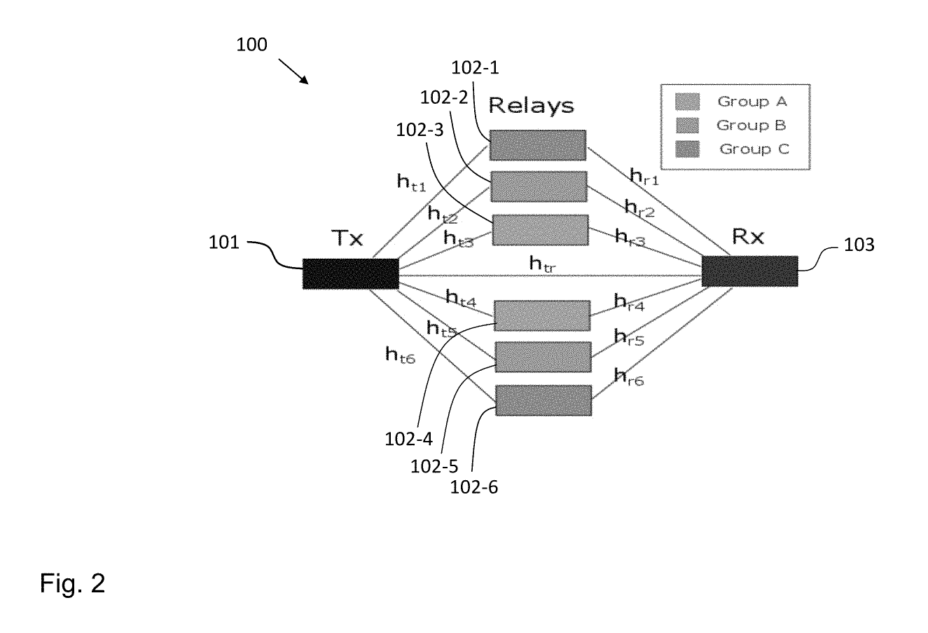

As already shown in FIG. 2, the relay communication devices 102 in close proximity to the transmitter communication device 101 towards a given receiver communication device 103 can be grouped into 3 categories: Group A comprising the relay communication devices 102-3 and 102-4 taking part in the first transmission; Group B comprising the relay communication devices 102-2 and 102-5 taking part in the re-transmission together with group A; Group C comprising the relay communication devices 102-1 and 102-6, which do not take part in current transmissions, but can be potential relays in future messages due to their geographical proximity.

The base station 104 or the transmitter communication device 101 may need to predict the path-loss of each channel hₓ shown in FIG. 2. The term “channel” is used to reflect the large scale fading mainly due to path-loss, and should not be confused with small-scale fading of channel estimation. The target is that the base station 104 or the transmitter communication device 101 will predict a CQI matrix C for the upcoming Tₚ seconds. The matrix at time instant tₒ can be represented as

$${C}_{N \times N}^{{t}_{o}} = [ \begin{matrix}1 & {V}_{12}^{{t}_{o}} & … & {V}_{1 N}^{{t}_{o}} \\ {V}_{21}^{{t}_{o}} & 1 & … & {V}_{2 N}^{{t}_{o}} \\ ⋮ & ⋮ & ⋱ & ⋮ \\ {V}_{N 1}^{{t}_{o}} & {V}_{N 2}^{{t}_{o}} & … & 1\end{matrix} ]$$

wherein N is the total number of nodes in the neighborhood of the TX and Vᵢⱼ^{t}^{ₓ} is the predicted pathloss between vehicle i and j at future time instant tₓ.

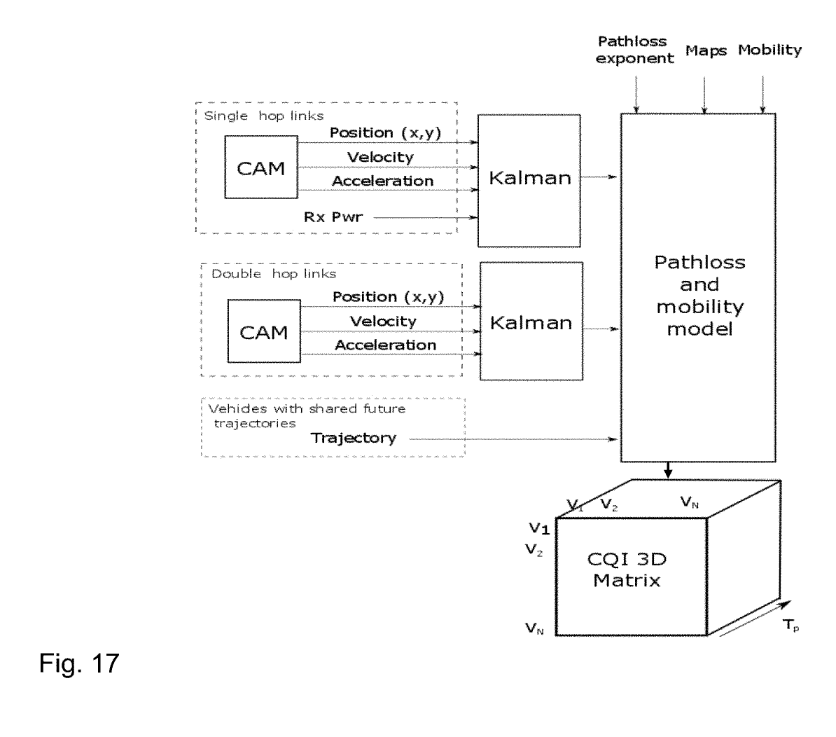

Using matrix C, the base station 104 or the transmitter communication device 101 has enough information to decide which relay communication devices 102 are selected for relaying when a mission-critical message is to be transmitted at a specific time instant in the future. The prediction of the path loss or the CQI can be implemented in the base station or the transmitter communication device 101 as illustrated in FIG. 17. As a first operation, the base station 104 or transmitter communication device 101 may need to predict the positions of all the vehicles in the future. Those positions can be estimated using the following classes of information:

Single hop links: Those are the links which the transmitter communication device 101 is part of. For those links the transmitter communication device 101 can use the received power from the transmit vehicles as well as information about position, velocity and acceleration. This information is input to a Kalman filter, which predicts the location of the single hop vehicles at certain window of time in the future. It is assumed that the transmission power is fixed i.e. 23 dBm.

Double hop links: Those are the links which the transmitter communication device 101 is not part of. In this case, the base station 104 or the transmitter communication device 101 uses only the CAM message information as inputs to the Kalman filter.

Vehicles with shared trajectory exchange: Since one of the use cases is lane merging, the base station 104 or the transmitter communication device 101 can make use of predicted trajectories which have been already shared by other vehicles previously.

As a second operation, the base station 104 or the transmitter communication device 101 can use a path loss and mobility model which is usually a characteristic of the geographical location of the network 100. For example, in urban environments the path-loss exponent is expected to be larger than rural environments. Additionally, the model can take into account the mobility of all the nodes in the surrounding. Nodes with large relative velocity should have lower effective SNR due to time selectivity of the channel. In addition, a map of the surrounding environment can be utilized. For example, in a cross-road the distance between two vehicles is close. However, due to the presence of a building in-between, the path loss becomes larger than of line of sight. Hence, maps can help improve the expected path loss exponents and model.

Finally, a 3D CQI matrix can be constructed which reflects the future channel qualities between all the vehicles in the vicinity of the transmitter communication device 101 for the next Tₚ seconds. Note that the time resolution of the prediction can depend on the periodicity of the CAM messages and possibly the trajectory exchange.

In order to minimize signaling overhead, the base station 104 or transmitter communication device 101 can “guess” which relay communication devices 102 have successfully decoded the first message and configure those relay communication devices 102 to perform a joint second transmission. The configuration procedure can be based on the so called Polyanskiy bound which has been explained above. For each relay, the probability that a relay communication device 102-i fails to decode the first message and fails to deliver the second message can be estimated by the following equation:

$${P}^{i} = Q ( \frac{nC ( {γ}_{1}^{i} ) - k}{\sqrt{n V ( {γ}_{1}^{i} )}} ) \cdot Q ( \frac{nC ( {γ}_{2}^{i} ) - k}{\sqrt{n V ( {γ}_{2}^{i} )}} ) . \qquad a$$

wherein Q(⋅)st he q-function, γ₁ⁱ and γ₂ⁱ denote the SNR of the first and second hop respectively, n is the blocklength size, k is the information message size, C(⋅) and V(⋅) are the Shannon capacity and the channel dispersion which are defined as

$$C ( γ ) = \frac{1}{2} {log}_{2} ( 1 + γ ) , \\ V ( γ ) = \frac{γ}{2} \frac{γ + 2}{{( γ + 1 )}^{2}} {log}_{2}^{2} ( e ) .$$

As a special case, the source can estimate its own direct link block error probability, which is defined as

$${P}^{o} = Q ( \frac{nC ( {γ}_{o}^{i} ) - k}{\sqrt{n V ( {γ}_{o}^{i} )}} )$$

Finally, the relay selection process can be mathematically represented as

$$arg {min}_{i} \{ {Q ( \frac{nC ( {γ}_{1}^{i} ) - k}{\sqrt{n V ( {γ}_{1}^{i} )}} )}^{α} \cdot Q ( \frac{nC ( {γ}_{2}^{i} ) - k}{\sqrt{n V ( {γ}_{2}^{i} )}} ) \} where$$

$$i ∈ \{ 0 , 1 , 2 , … , N \}$$

wherein α is an exponent highlighting the importance of decoding the first transmission, and N is the total number of relay communication devices 102 taking part in the first transmission.

As aforementioned, the Alamouti technique is an open loop precoding technique which needs minimal interaction between transmitting antennas. The Alamouti technique uses exactly two antennas which are one antenna per relay vehicle according to embodiments of the invention. Without going into mathematical details of Alamouti precoding, each antenna performs a certain “role” in the pre-coding procedure. Each antenna is assigned a role A or a role B. The base station 104 or the transmitter communication device 101 can pick up two relays according to the criteria explained above and assign each relay communication device 102 a role, either A or B.

In unicast, the operation is straightforward. The base station 104 or the transmitter communication device 101 configures the best two relay communication devices 102 to the single receiver communication device 103 and assigns each one of them a role, either “A” or “B”. However, in multicast the situation is different. A pair of relay communication devices 102 is assigned to each receiver communication device 103. Although using one pair of relay communication devices 102 for all receiver communication devices 103 is manageable, the achievable SNR for all receiver communication devices 103 may not be sufficient if the receiver communication devices 103 are distributed far away from each other. Hence pairs of relay communication devices 102 can be assigned to each receiver communication device 103.

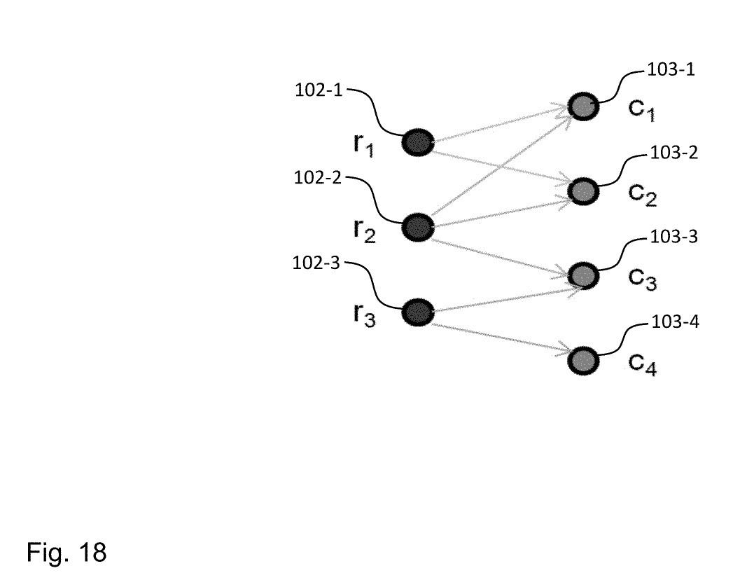

FIG. 18 shows a possible setup of relay communication devices 102 and receiver communication devices 103. In this case, the base station 104 or the transmitter communication device 101 configures r1 to be role A for the receiver communication devices 103-1 and 103-2 (i.e. c1 and c2), whereas r3 is configured to be r3 for receiver communication devices 103-3 and 103-4 (i.e. c3 and c4). The relay communication device r2 is a joint node which plays the role of antenna “B” for receiver communication devices 103-1, 103-2 and 103-3 (i.e. c1, c2 and c3). The receiver communication device 103-4 (i.e. c4) may be far away from r2; hence, it may only receive the signal from r3, which is still sufficient for decoding the message.

In terms of signaling, the base station 104 or the transmitter communication device 101 can send a matrix defining the antenna role of each relay communication device 102 to each receiver communication device 103. No relay communication device 102 should have two roles at the same time. As an example shown in FIG. 18, the matrix may be constructed as

$$[ \begin{matrix}A & B & 0 \\ A & B & 0 \\ 0 & B & 1 \\ 0 & 0 & A\end{matrix} ]$$

wherein the column indicates relay ID and the row indicates the receiver ID.

While a particular feature or aspect of the disclosure may have been disclosed with respect to only one of several implementations or embodiments, such feature or aspect may be combined with one or more other features or aspects of the other implementations or embodiments as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the embodiments of the invention beyond those described herein. While the present embodiments of the invention has been described with reference to one or more particular embodiments, those skilled in the art recognize that many changes may be made thereto without departing from the scope of the present embodiments of the invention. It is therefore to be understood that within the scope of the appended claims and their equivalents, the embodiments of the invention may be practiced otherwise than as specifically described herein.

1. A base station for cellular communication with a plurality of communication devices in a cellular communication network using a cellular communication channel, wherein the plurality of communication devices include a transmitter communication device, a plurality of relay communication devices and at least one receiver communication device and are configured for device to device (D2D) communication with each other using a D2D communication channel, the base station comprising:
a communication interface configured to receive a request from the transmitter communication device for transmitting a communication message from the transmitter communication device to the at least one receiver communication device; and
a processor configured to select a subset of the plurality of relay communication devices for relaying the communication message to the at least one receiver communication device and to configure the subset of relay communication devices to relay the communication message using one of a plurality of relay modes, including a first relay mode and a second relay mode, wherein the first relay mode is an amplify and forward relay mode and wherein the second relay mode is a decode and forward relay mode.

2. The base station of claim 1, wherein the processor is configured to estimate a quality measure of the D2D communication channel between the transmitter communication device and the receiver communication device and to instruct the transmitter communication device to transmit the communication message without the relay communication devices to the receiver communication device, in case the estimated quality measure is larger than a quality measure threshold, wherein the estimated quality measure includes a signal-to-noise ratio or a packet reception probability.

3. The base station of claim 1, wherein the processor is configured to select the subset of relay communication devices on the basis of a respective quality measure associated with each relay communication device, wherein the respective quality measure is based on the quality of the D2D communication channel between the transmitter communication device and the respective relay communication device and on the quality of the D2D communication channel between the respective relay communication device and the receiver communication device, wherein the respective quality measure includes a signal-to-noise ratio.

4. The base station of claim 3, wherein the processor is configured to select the subset of relay communication devices by selecting the relay communication devices, for which an associated signal-to-noise ratio leads to an estimate of the block error rate based on the Polyanskiy bound or a variant thereof that is smaller than a block error rate threshold.

5. The base station of claim 1, wherein the processor is configured to select the subset of relay communication devices on the basis of information about a position and/or a velocity of each relay communication device by predicting for each relay communication device a first channel quality of the D2D communication channel between the transmitter communication device and the relay communication device and a second channel quality of the D2D communication channel between the relay communication device and the receiver communication device.

6. The base station of claim 5, wherein the processor implements a Kalman filter and wherein the Kalman filter is configured to predict for each relay communication device the first channel quality and the second channel quality on the basis of a device position and velocity mobility model and/or a path loss model.

7. The base station of claim 1, wherein for configuring the subset of relay communication devices the processor is configured to transmit via the communication interface a first control message for informing the subset of relay communication devices to relay the communication message using the first relay mode.

8. The base station of claim 7, wherein the first control message comprises information for identifying one or more communication resource blocks for transmitting the communication message.

9. The base station of claim 7, wherein, after transmitting the first control message and in response to receiving information that the receiver communication device was not able to decode the communication message, the processor is configured to re-configure the subset of relay communication devices to transmit via the communication interface a second control message for informing the subset of relay communication devices to relay the communication message to the receiver communication device using the second relay mode.

10. The base station of claim 1, wherein the base station is configured to relay the communication message from the transmitter communication device to the at least one receiver communication device using the cellular communication channel and wherein the processor is configured to select the base station as part of the subset of the plurality of relay communication devices for relaying the communication message to the at least one receiver communication device.

11. The base station of claim 1, wherein the processor is configured to select one or more neighbouring base stations of the base station as part of the subset of the plurality of relay communication devices for relaying the communication message to the at least one receiver communication device and to inform the selected one or more neighbouring base stations to relay the communication message to the at least one receiver communication device.

12. A transmitter communication device for cellular communication with a base station in a cellular communication network using a cellular communication channel and device to device (D2D) communication with a plurality of communication devices using a D2D communication channel, the plurality of communication devices including a plurality of relay communication devices and at least one receiver communication device, the transmitter communication device comprising:
a communication interface; and
a processor configured to select on the basis of a cellular communication state of the receiver communication device a first communication message transmission mode or a second communication transmission mode;
wherein in the first communication message transmission mode the processor is configured to transmit via the communication interface a request to the base station for transmitting a communication message from the transmitter communication device to the receiver communication device; and
wherein in the second communication message transmission mode the processor is configured to select a subset of the plurality of relay communication devices for relaying the communication message to the receiver communication device and to configure the subset of relay communication devices to relay the communication message using one of a plurality of relay modes, including a first relay mode and a second relay mode, wherein the first relay mode is an amplify and forward relay mode and wherein the second relay mode is a decode and forward relay mode, wherein the communication interface is configured to transmit the communication message to the one or more receiver communication devices via the subset of relay communication devices.

13. The transmitter communication device of claim 12, wherein the cellular communication state of the at least one receiver communication device comprises a radio resource control (RRC) idle state, a RRC connected state and an Out of coverage state.

14. The transmitter communication device of claim 12, wherein the at least one receiver communication device comprises a first receiver communication device in a first cellular communication state including a RRC connected state, and a second receiver communication device in a second cellular communication state including a RRC Idle state or Out of coverage state, and wherein the processor is configured to select the first communication message transmission mode for transmitting the communication message to the first receiver communication device and the second communication transmission mode for transmitting the communication message to the second receiver communication device.

15. A method of operating a base station for cellular communication with a plurality of communication devices in a cellular communication network using a cellular communication channel, wherein the plurality of communication devices include a transmitter communication device, a plurality of relay communication devices and at least one receiver communication device and are configured for device to device (D2D), communication with each other using a D2D communication channel, the method comprising:
receiving a request from the transmitter communication device for transmitting a communication message from the transmitter communication device to the at least one receiver communication device;
selecting a subset of the plurality of relay communication devices for relaying the communication message to the at least one receiver communication device; and
configuring the subset of relay communication devices to relay the communication message using one of a plurality of relay modes, including a first relay mode and a second relay mode, wherein the first relay mode is an amplify and forward relay mode and wherein the second relay mode is a decode and forward relay mode.

16. The method according to claim 15, further comprising:
estimating a quality measure including a signal-to-noise ratio or a packet reception probability, of the D2D communication channel between the transmitter communication device and the receiver communication device; and
instructing the transmitter communication device to transmit the communication message without the relay communication devices to the receiver communication device, in case the estimated quality measure is larger than a quality measure threshold.

17. A method of operating a transmitter communication device for cellular communication with a base station in a cellular communication network using a cellular communication channel and device to device (D2D), communication with a plurality of communication devices using a D2D communication channel, the plurality of communication devices including a plurality of relay communication devices and at least one receiver communication device, the method comprising:
selecting, by the transmitter communication device, on the basis of a cellular communication state of the receiver communication device a first communication message transmission mode or a second communication transmission mode;
transmitting, by the transmitter communication device in the first communication message transmission mode, via a communication interface a request to the base station for transmitting a communication message from the transmitter communication device to the receiver communication device, or
selecting, by the transmitter communication device in the second communication message transmission mode, a subset of the plurality of relay communication devices for relaying the communication message to the receiver communication device; and
configuring the subset of relay communication devices to relay the communication message using one of a plurality of relay modes, including a first relay mode and a second relay mode, wherein the first relay mode is an amplify and forward relay mode and wherein the second relay mode is a decode and forward relay mode, wherein the communication interface transmits the communication message to the one or more receiver communication devices via the subset of relay communication devices.

18. The method according to claim 17, wherein the cellular communication state of the at least one receiver communication device comprises a radio resource connected (RRC) idle state, a RRC connected state and an Out of coverage state.

19. The method according to claim 18, wherein the at least one receiver communication device comprises a first receiver communication device in a first cellular communication state including a RRC connected state, and a second receiver communication device in a second cellular communication state including a RRC idle state or Out of coverage state, the method further comprising:
selecting the first communication message transmission mode for transmitting the communication message to the first receiver communication device and the second communication transmission mode for transmitting the communication message to the second receiver communication device.

20. A computer program product, comprising:
a non-transitory computer-readable medium storing computer executable instructions, wherein the instructions comprise:
instructions for receiving a request from a transmitter communication device for transmitting a communication message from the transmitter communication device to at least one receiver communication device;
instructions for selecting a subset of a plurality of relay communication devices for relaying the communication message to the at least one receiver communication device; and
instructions for configuring a subset of relay communication devices to relay the communication message using one of a plurality of relay modes, including a first relay mode and a second relay mode, wherein the first relay mode is an amplify and forward relay mode and wherein the second relay mode is a decode and forward relay mode.
